(19) United States
(12) Patent Application Publication
(10) Pub. No.: US 2024/0239078 A1
(43) Pub. Date: Jul. 18, 2024

(54) FOOD PACKAGING PRODUCED BY ULTRASONIC AND/OR INDUCTION SEALING OF RIGID CELLULOSE BODIES AND METHOD OF PRODUCTION THEREOF

(71) Applicant: SOCIETE DES PRODUITS NESTLE S.A., Vevey (CH)

(72) Inventors: JULIEN BRAS, St Martin d'Uriage (FR); JULIA CHARDOT, Buc (FR); AGATHE MOUREN, La Seyne Sur Mer (FR); KARIM MISSOUM, Pusignan (FR); PASCAL GIRARDIN, Grandvaux (CH)

(21) Appl. No.: 18/559,945

(22) PCT Filed: May 10, 2022
(86) PCT No.: PCT/EP2022/062540

§ 371 Date: Nov. 9, 2023

(30) Foreign Application Priority Data
May 11, 2021 (EP) 21173375.3

(51) Int. Cl. B31B 50/64; B29C 65/08; B29C 65/36; B29L 31/00; B65B 51/22

(52) U.S. Cl. CPC B31B 50/64; B29C 65/08; B29C 65/3616; B65B 51/225; B65B 51/227; B29L 2031/7158; B29L 2031/7162

(57) ABSTRACT

The present invention relates to a method of making a container (300). At least two laminated rigid bodies (101, 102) are provided. Each of the rigid bodies (101, 102) is made of a rigid cellulose body (110) and a laminate (120) that is laminated thereon. The rigid bodies (101, 102) are adjoined at interface sections (130) thereof so that they together enclose an inner volume (311), which is at least partially delimited by the laminate (120). The rigid bodies (101, 102) are joined by ultrasonic welding and/or induction sealing of the interface sections (130) to form the container (300). The present invention relates further to a container (300) that is formed in accordance with the method of the invention.

### 1. FIELD OF THE INVENTION

The invention relates to a method of making a container from two laminated cellulose bodies. The invention also relates to a container made from laminated cellulose bodies.

### 2. TECHNICAL BACKGROUND

In the prior art, a number of packaging applications, such as the packaging of food products, relies on plastic materials as a packaging material. Reasons for this are that plastic materials offer numerous advantages, such as formability, durability, flexibility, low weight, provision of long shelf-life and leaving the packaged product unaltered. Unfortunately, disposing, reusing and recycling of plastic materials is challenging.

Therefore, attempts are made to replace plastic materials with alternative materials that overcome the problems with disposing and/or recycling of used packaging. For example, bioplastics and fibre-based materials, such as paper, cardboard or pulp, are proposed as alternatives to plastic materials as they facilitate recycling and/or composting. Often, fibre-based materials are laminated with (bio-)plastic materials to arrive at a packaging material that has characteristics of both materials and that is similar to plastic materials.

The use of new materials in the production of packaging brings with it technical challenges. For example, the thermal conductivity of fibre-based materials is low in comparison to plastic materials. For instance, the thermal conductivity of fibre-based materials is approximately a tenth of the thermal conductivity of plastic materials. Thus, sealing methods, which primarily rely on heat being conductively transferred through the workpieces, are time expensive as it takes time until the heat penetrates the workpieces sufficiently to heat up a sealing area. Moreover, the sealing result is often unsatisfactory when applying such sealing methods to the new materials. In particular, it appears to be difficult to provide liquid proof or gas tight sealing.

The aforementioned problems appear to exist in particular if the workpieces to be sealed exceed a certain material thickness at the sealing area. The situation may be also aggravated if the respective materials are relatively compact or dense. Consequently, it becomes clear that, in such configurations, the aforementioned sealing methods (such as heat sealing) are unsuitable for using the above-described new materials in packaging applications that place high demands on the sealing quality and require liquid proof or gas tight sealing, for example. Hence, these packaging applications either must still rely on plastic materials or are restricted to packaging with relatively thin walls.

However, the use of plastic material is disadvantageous due to the ecological impact of the packaging. Furthermore, packaging applications of various technical fields (e.g. food packaging) require that the packaging has a certain amount of material thickness to provide the packaging with defined mechanical and chemical properties (e.g. certain level of mechanical stiffness; impermeability to foreign matter, e.g. bacteria/gas). Accordingly, limiting the packaging to certain material strengths is not a viable option in many applications.

Therefore, it is an object of the invention to provide a method of making a container and a container that allow to overcome the known drawbacks of the prior art, respectively.

In particular, it is an object of the invention to provide a method that ensures reliable liquid and/or gas tight sealing of fibre-based workpieces despite each workpiece having a relatively high material thickness at the sealing area. Also, it is an object of the invention to provide a container from a fibre-based material that possesses at the sealing area a relatively high material thickness as well as reliable liquid and/or gas tight sealing. It is a further object of the invention to provide a container and a method for producing a gas and/or liquid tight container so that process and sealing times can be reduced.

### 3. SUMMARY OF THE INVENTION

These and other objects, which become apparent upon reading the description, are solved by the subject-matter of the independent claims. The dependent claims refer to preferred embodiments of the invention.

A first aspect of the invention relates to a method of making a container. Therein, at least two laminated rigid bodies are provided that are each made of a rigid cellulose body and a laminate that is laminated on at least part of the rigid cellulose body. The rigid bodies are adjoined at interface sections thereof so that they together enclose an inner volume. The inner volume is at least partially delimited by the laminate. The rigid bodies are joined by ultrasonic welding and/or induction sealing of the interface sections to form the container.

In other words: a process of (constructing or) fabricating (an object or) a receptacle for receiving and storing substances is provided. Preferably, the substance may be a food product. The container is produced from at least two (separate) components that are each at least partially covered with a laminate. The laminate may be provided on the inside or the outside of the container. For example, one of the two laminated rigid bodies may have the laminate provided on at least a part of an external surface of the container (i.e. facing away from the inner volume) while the respective other rigid body may be provided with a (different) laminate on a surface facing inside (into the inner volume of) the container.

Therein, the term “laminate” may be understood as a film, a membrane, or a thin sheet of material (for lamination). Preferably, before lamination, the laminate may be a material separate from the object to be laminated. Accordingly, after lamination, a laminated object may have a structure, for example, comprising different parts that may be arranged in layers, plies, slats, tiers or as strata, wherein preferably the laminate may form (at least) one of the layers, plies, slats, tiers or strata.

The rigid bodies forming the container as well as their respective cellulose bodies (being components of the rigid bodies) are rigid. The cellulose body may have an open structure, such as a frame or shell, and/or may form a skeleton or core of its rigid body.

Therein, the term “rigid” may be understood as an ability of the material to resist deformation in response to an applied mechanical load; e.g. of a product filled in the inner volume or a gripping force of a user to grasp and carry the container preferably filled with a product. This ability may preferably originate from a compactness of the material of the respective body or may be inherent to the respective body due to its structural design. For example, the rigid (cellulose) bodies may show a porosity and/or density that facilitates the material being mechanically inflexible and/or being gas impermeable to a certain extent. For fibre-based materials, for example, the bending stiffness may be determined in tests following ISO 2493. For example, the rigid body may comprise a bending stiffness between 400 Nm and 3500 Nm. The rigid body may preferably comprise a grammage between 300 g/m² and 800 g/m². Preferably, the rigid body may comprise a density in the range of 250 kg/m³ to of 1000 kg/m³. Further, the rigid body may comprise a porosity (expressed as a fraction of the volume of voids over the total volume as a percentage) between 1% and 20%.

The rigid bodies are adjoined (and joined) at interface sections, i.e. via structures for forming a (permanent structural) connection therebetween. Preferably, each of the rigid bodies may have at least one interface section. The interface section(s) of the rigid body may be a (part of a) surface (facing outside or inside with respect to the inner volume) and/or may be a structure of the rigid body for adjoining and joining the rigid bodies.

A(n inner) volume at least partially enclosed (surrounded) by the rigid bodies is formed by adjoining (i.e., for example, combining, or aligning and neighbouring) the two rigid bodies. The inner volume may extend inside the container. The inner volume is at least partially delimited by the laminate of at least one (or both) of the rigid bodies.

The adjoined rigid bodies are (permanently) connected (coupled, linked and/or united) to each other by ultrasonic welding and/or induction sealing. Preferably, the adjoined rigid bodes are joined to each other by performing sealing such that heat is generated only at the sealing location. More preferred, the two rigid bodies may be joined by generating heat immediately (directly) at the sealing location, which preferably is sandwiched between material (or portions) of the rigid bodies to be sealed.

“Ultrasonic welding” is generally known in the prior art. In an ultrasonic welding process, high-frequency ultrasonic vibrations can be used to create a local structural bond between two workpieces. For this, the workpieces can be sandwiched (with or without the application of additional pressure) between a sealing anvil and a sonotrode. The sonotrode converts the high-power electric signal of an electronic ultrasonic generator into a mechanical high-frequency vibration that is applied to the workpieces. The sealing anvil provides a (work) surface to counteract the high-frequency vibration.

Similarly, “induction sealing” is also generally known in the prior art. In an induction sealing process, a structural bond between two workpieces is created by heating an electrically conducting portion of at least one of the two work pieces by electromagnetic induction. For this, the workpieces may be placed (with or without the application of additional pressure) under an electromagnet that is connected to an electronic oscillator. Typically, the electronic oscillator passes a high-frequency alternating current (AC) through the electromagnet, thereby creating an alternating magnetic field.

In the prior art, ultrasonic welding and induction sealing were found unsuitable for joining two rigid cellulose bodies as the excess of a certain material strength at the sealing area was considered an obstacle for forming a reliable bond between such structures. Also, cellulose bodies can show an inhomogeneity of the material that can impact the consistency and quality of corresponding sealing. However, the inventors have surprisingly found that ultrasonic as well as induction sealing of rigid cellulose bodies under the defined conditions set out above can lead to particularly strong and reliable sealing bonds between the cellulose bodies.

By using ultrasonic welding for joining the two rigid bodies together, it is not necessary to penetrate the material of the two rigid bodies with heat as ultrasonic welding is based on a mechanically induced temperature increase at the sealing interface.

Similarly, by using induction sealing, it is unnecessary to penetrate the material of the two rigid bodies with heat as induction sealing is based on heat being generated inside the electrically conducting portion of the workpiece itself. Thus, it can be avoided having to rely on heat conduction for bonding the workpieces.

The inventors have found that it is also possible to use during the bonding process both sealing methods, namely ultrasonic welding and induction sealing, either at different locations of the cellulose bodies or subsequently from each other.

Thereby, sealing of rigid bodies can be completed in an effective and timely manner: For example, the method of the invention allows increasing the sealing strength of the sealing. Thereby, typical sealing failures, such as delamination, adhesive or cohesive failure, occur only with the application of comparatively high forces (e.g. 100 N or more). Moreover, the container can be provided with (hermetic) sealing forming a gas and/or liquid barrier. In addition, it is possible to join the two rigid bodies in sealing times that last less than one second. Therein, the process offers a further opportunity to reduce process times by customizing the shape of the sonotrode or electromagnet. For example, the sonotrode or electromagnet may be provided in the shape of the container so that the sealing can be formed in a single step. Furthermore, the process enables sealing of the container after being filled since heat is generated only at the sealing area and thus, the risk of contaminating or otherwise affecting the container's content can be reduced. Of course, the container may also be filled after sealing and then preferably closed by an additional lid or cap, e.g. reversibly or irreversibly attached to the container, if required.

Thus, the invention allows to overcome the known disadvantages of the prior art.

According to a preferred embodiment, at least one or both of the rigid bodies may have a three-dimensional form. At least one rigid body may have a wall section delimiting an open body volume. The inner volume may preferably comprise the open body volume. Hence, a container can be produced with a volume that is enclosed by a body structure of at least one of the rigid bodies. Thereby, product inside the container can be stored safely so that the shelf-life of the product can be increased.

According to a further preferred embodiment, each of the rigid bodies may have a circumferential flange section. The flange section may form the interface section(s), respectively. Preferably, the flange sections may at least partially overlap with each other when the rigid bodies are adjoined. Alternatively or additionally, the flange sections may preferably extend in a plane, respectively. Preferably, the flange section may extend laterally from the rigid body in (always) the same direction. Alternatively or additionally, the flange section may extend in a step-free (e.g. without discontinuities) and/or continuous manner. Alternatively or additionally, the curvature of the flange section may be constant along its circumferential extension. Alternatively or additionally, the flange section may project always to the same side with respect to the inner volume along its extension direction.

By providing a structure that may extend at least partially along an outside edge of one of the rigid bodies, a dedicated structure for aligning and adjoining the two rigid bodies can be provided. The flange section may be used for guiding the rigid bodies to cover at least partially the interface section of the respective other rigid body. The flange section may also be used to guide the sonotrode in the ultrasonic welding process and/or the electromagnet in the induction sealing process. Thereby, the two rigid bodies can be joined accurately, efficiently and only at locations that are intended to be connected. Thus, a sealing of high quality and with required specifications can be provided within a short time.

According to a preferred embodiment, the flange section has no microdents after the ultrasonic welding process.

According to a further preferred embodiment, the interface sections may be each laminated with the laminate. Preferably, by being laminated with the laminate, the laminate may allow for joining the rigid bodies (preferably in the respective sealing process).

Thereby, it is possible to use the laminate as a sealant for joining the two rigid bodies. This allows to tailor the qualities and characteristics of the sealing between the two rigid bodies to the requirements of the packaging application. In addition, the cellulose body of the respective rigid body can be provided with a protective layer at the interface section. For instance, by providing the interface section with a barrier layer against water, it can be avoided that the container is weakened at the interface section in case of being exposed to water, e.g. during the transport.

According to a further preferred embodiment, the step of ultrasonic welding may be carried out with a frequency in a range of 15 kHz to 30 kHz, preferably at 20 kHz. Alternatively or additionally, the step of induction sealing may be carried out with a power level in a range of 0.5 kW to 6.0 kW, more preferred 3.0 kW to 4.0 kW. Alternatively or additionally, in the step of induction sealing the magnetic field may vary with a frequency in a range of 5 kHz to 100 kHz, preferably at 50 kHz.

Thereby, a strong sealing connection can be formed between the two rigid bodies within a short time. Further, it was found that the above frequencies are particularly suitable for the intended material combinations.

According to a preferred embodiment, the step of joining may last in a range from 0.01 seconds to 1 seconds, preferably in a range from 0.1 to 0.2 seconds.

Thereby, it can be avoided that the sealing connection between the two rigid bodies is formed insufficiently, for example, by being either over-welded or under-welded. Also, the quality of the sealing can be improved with such configuration even further.

According to a preferred embodiment, the ultrasonic device has no head provided with microprojections.

According to a further preferred embodiment, at least one of the rigid cellulose bodies may comprise a see-through hole that is covered by the laminate. Preferably, the see-through hole may be provided at a (or the) wall section of the rigid cellulose body that delimits the inner volume.

The provision of a see-through hole in a wall section of the body allows to use vacuum lamination for laminating cellulose bodies that are more compact, structurally more complex, and larger in size (depth) as the see-through hole facilitates an even and equal distribution of suction forces across the surface of the body to be laminated. In addition to being a facilitator for the vacuum lamination process, the see-through opening can be used as a filling level indicator or visualizer of the product. Therein, the see-through hole can be an eye catcher visualising the quality of the product and improving the aesthetics of the packaging.

According to a preferred embodiment, a food product may be provided in the inner volume. Preferably, the food product may be provided before or after joining the rigid bodies.

This configuration enables storage of a (food) product in a container that comprises gas tight and/or liquid tight sealing so that the shelf-life of the product can be improved. Moreover, using ultrasonic welding and/or induction sealing offers the additional advantage that the risk of changing the consistency of the food product during the sealing process is reduced as the sealing is confined to the sealing area and other sections of the container are not subjected to heat. Also, the risk of contaminating the product by melting other sections of the container during the joining step can be reduced. Moreover, ultrasonic welding as well as induction sealing can be completed even if product adheres to the sealing area.

A further aspect of the invention relates to a container. The container comprises at least two laminated rigid bodies. Each of the rigid bodies is made of a rigid cellulose body and a laminate that is laminated on at least part of the rigid cellulose body. The rigid bodies are joined by ultrasonic welding and/or induction sealing at interface sections thereof so that the rigid bodies together enclose an inner volume of the container. The inner volume is at least partially delimited by the laminate.

In other words: a container can be provided, which is formed by two rigid bodies that are (permanently) joined through ultrasonic welding and/or induction sealing, and that surround (or envelope) at least partially a space enclosed therebetween.

Thereby, a container can be provided that can be fabricated in a short time and that comprises gas tight and/or liquid tight sealing of high quality. As a result, it is possible to increase the shelf-life of products that are filled inside the container. In addition, it is possible to use fibre-based materials for forming the container without being restricted to a certain material strength.

Preferably, the rigid cellulose body and the laminate (of each of the rigid bodies) may be laminated in a (skin) vacuum lamination process.

Accordingly, the adhesion of the laminate to the rigid cellulose body can be improved, thereby improving the barrier properties of the container.

According to a preferred embodiment, at least one or both of the rigid bodies may have a three-dimensional form. Preferably, at least one or both of the rigid bodies may have a wall section delimiting an open body volume. Preferably, the inner volume of the container may comprise the open body volume of at least one or both of the rigid bodies.

Thereby, the inner volume of the container can be (completely) enclosed by a structure of the rigid bodies. This allows safely storing a product contained inside the container.

According to a further preferred embodiment, the interface sections may be circumferential flanges. Preferably, the circumferential flanges may extend in a plane, respectively. Preferably, each of the interface sections and/or of the circumferential flanges may be laminated with the laminate.

Thereby, the container can be formed more efficiently and the sealing can be performed more easily. Accordingly, the quality of the sealing of the container can be increased.

According to a preferred embodiment, at least one of the rigid cellulose bodies may comprise a see-through hole that may be covered by the laminate. Preferably, the see-through hole may be provided at the wall section. Alternatively or additionally, at least the at least one rigid cellulose body may comprise a plurality of see-through holes that may be covered by the laminate and that preferably may be provided at the wall section. More preferred, the see-through holes may be evenly or unevenly distributed over the rigid cellulose body or at least over its wall section.

Thereby, it is possible to use the see-through opening as a filling level indicator or visualizer of the product. For example, the see-through hole can be used as an eye catcher visualising the quality of the product. Moreover, the see-through hole may allow to use vacuum lamination for laminating cellulose bodies that are more compact, structurally more complex, and larger in size (depth) as the see-through hole facilitates an even and equal distribution of suction forces across the surface of the body to be laminated. Accordingly, the container can be designed more freely.

According to a further preferred embodiment, the largest extension E of the see-through hole may be E≤20 mm or E≤15 mm or E≤10 mm. Alternatively or additionally, the largest extension E may be E≥1 mm or E≥2 mm. It is also conceivable that the largest extension E of the see-through hole may be in a range of 1 mm≤E≤10 mm or 2 mm≤E≤5 mm. For example, the largest extension E may be the diameter of the see-through hole.

Thereby, a balance can be found between the structural integrity of the container and the ability of improving the quality of the adhesion (bond) between the laminate and the cellulose body in a vacuum lamination process. Also, such configuration facilitates that product inside the container can comfortably be seen through the see-through hole.

According to a preferred embodiment, the rigid cellulose body may be made from a cellulose material or fibre-based material, like moulded pulp. For example, the cellulose or fibre-based material may be wood pulp, sugarcane pulp, bagasse pulp, non-wood pulp, and/or cellulose based pulp in any form.

Thereby, it is possible to provide the container from a recyclable, biodegradable and/or compostable material so that the ecological impact thereof can be reduced. Moreover, the above materials allow to mould the respective cellulose bodies in accordance with the required shape so that the areas of application can be increased.

According to a further preferred embodiment, the rigid cellulose body may have a material thickness B of 200 μm≤B≤1200 μm, preferably 200 μm≤B≤1000 μm.

Thereby, the rigidity and/or compactness of the container can be ensured and increased. Moreover, the container can be provided with a sufficient gas barrier and mechanical strength that is frequently required in packaging applications.

According to a further preferred embodiment, the laminate of each rigid body may have a material thickness T of 25 μm≤T≤150 μm, preferably 60 μm≤T≤100 μm.

Thereby, a balance can be found between providing the see-through hole and/or the inside of the container with a layer of laminate, which offers sufficient strength and sealing properties, while keeping the laminate stretchable. Also, it is possible to attach the so configured laminate evenly and firmly to the cellulose body in a vacuum lamination process, thereby improving the barrier properties of the container.

According to a preferred embodiment, the laminate may comprise (or be) a recyclable, compostable and/or biodegradable material, preferably a polymer material. Alternatively or additionally, it may comprise (or be) a bio-based or petro-based material, preferably polymer material.

Alternatively or additionally, the laminate may comprise at least one layer or portion (section) that comprises an electrically conducting material, such as a metallic material (e.g. Aluminium, tin) or a conductive polymer. For example, the electrically conducting material may be provided as strands embedded in polymer material. The electrically conducting material may be a metallized polymer, metallized film and/or metallized paper. Alternatively or additionally, the electrically conducting material may be a blend between an electrically conducting material and a non-conducting material, such as a blend between a polymer and a metal. Preferably, the electrically conducting material layer or portion of the laminate may have a thickness of 5 μm to 50 μm, preferably 20 μm to 35 μm.

Therein, the term “compostable” may be understood as meaning that a material may be substantially broken down into organic matter within a few weeks or months when it is composted. This may be accomplished in industrial composting sites and/or home composters. Specific conditions relating to wind, sunlight, drainage and other factors may exist at such sites. At the end of a composting process, the earth may be supplied with nutrients once the material has completely broken down. International standards, such as EU 13432 or US ASTM D6400, provide a legal framework for specifying technical requirements and procedures for determining compostability of a material. For example, one of the tests for compostability requires that—to be considered “industrially compostable”—at least 90% of the material in question is to be biologically degraded under controlled conditions within 6 months. Similar tests exist for certification as home composting.

In comparison, the expression “biodegradable material” may be understood as any material that can be broken down into environmentally innocuous products by (the action of) living things (such as microorganisms, e.g. bacteria, fungi or algae). This process could take place in an environment with the presence of oxygen (aerobic) and/or otherwise without presence of oxygen (anaerobic). This may be understood, for example, as meaning that composting can be carried out without reservation. At the end of such composting processes, there are no residues of the material, which may be problematic for the environment, or any non-biodegradable components.

Thereby, it is possible to reduce the environmental impact of the container and to facilitate recycling and/or composting thereof after its usage.

Preferably, the laminate may comprise or may be made of a stretchable material, such as a polymer material. For example, the laminate may have a tensile strength between 10 MPa and 100 MPa.

Thereby, the see-through hole can be provided with a material that is able to dissipate a mechanical load irrespective of the side of the see-through hole, where it is applied to.

Alternatively or additionally, a translucent and/or transparent material may be used for (at least parts of) the laminate, such as a polymer material. Preferably, the material may include a filter for certain wavelengths of light that may deteriorate the quality of food products.

Thereby, the see-through hole can be provided as visually transmitting so that it can be used as a level indicator or as an opening for product visualisation.

According to a further preferred embodiment, the laminate may comprise a layered structure and preferably comprises any combination of one or more of the group of polyhydroxyalkanoates (PHA), polypropylene (PP), polyethylene (PE), polyethylene terephthalate (PET), polyglycolic acid (PGA), polylactic acid (PLA), polybutylene adipate terephthalate (PBAT), thermoplastic starch (TPS), polybutylene succinate (PBS), and/or metal, such as Aluminium or tin.

Thereby, the laminate can be provided from materials that are resistant to water and/or fat. Moreover, the materials may have barrier properties to block gas or external matter passing through the container and/or through the see-through hole. In addition, the materials can be provided with tensile strength sufficient for transportation purposes. Further, the materials may be biodegradable and/or may be sourced from plants.

According to a preferred embodiment, the inner volume may be at least partially filled with a food product. For example, the food product may be liquid, viscous, pasty, powdery, crumbly, or pourable.

This configuration enables storage of food products in a gas tight and/or liquid tight container so that the shelf-life of the product can be improved.

A further aspect of the invention relates to a container produced with the method of making a container as described above.

### 4. BRIEF DESCRIPTION OF DRAWINGS

Further features, advantages and objects of the invention will become apparent for the skilled person when reading the following detailed description of embodiments of the invention and when taking in conjunction with the figures of the enclosed drawings. In case numerals have been omitted from a figure, for example for reasons of clarity, the corresponding features may still be present in the figure.

FIG. 1 shows a schematic sectional side view of an example for a laminated rigid body for forming a container according to the invention.

FIG. 2 shows a further schematic sectional side view of an example for a laminated rigid body for forming a container according to the invention.

FIG. 3 shows a schematic sectional top view of an embodiment of a container according to the invention.

FIG. 4 shows a schematic sectional side view of another embodiment of a container according to the invention.

### 5. DETAILED DESCRIPTION

The Figures show different views and aspects of embodiments of the invention.

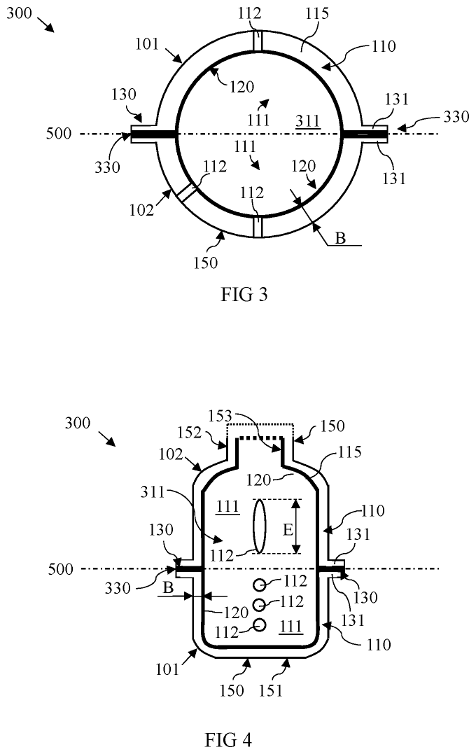

A first aspect of the invention relates to a container 300. An exemplary sectional top view of the container 300 is shown in FIG. 3 and an exemplary sectional side view of the container 300 is shown in FIG. 4. The container 300 may be a receptacle for food products. For example, the container 300 may be a tray, a (small) capsule, a bottle, a box and/or a stand-up packaging. The container 300 may have any size, shape or form.

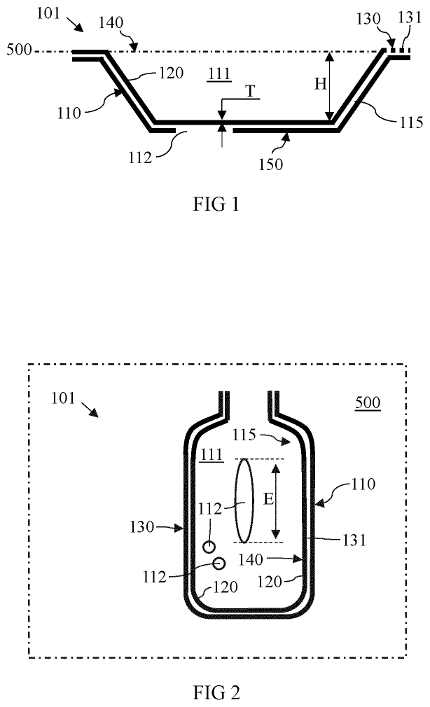

The container 300 comprises at least two rigid bodies 101, 102, namely at least a first rigid body 101 and a second rigid body 102. The first rigid body 101 is exemplarily shown in all Figures while the second rigid body 102 is exemplarily shown in FIGS. 3 and 4 only. However, the exemplary illustrations in FIGS. 1 and 2 are equally applicable to the second rigid body 102.

Preferably, at least one or both of the rigid bodies 101, 102 may have a three-dimensional form. Thus, the rigid bodies 101, 102 may extend in three-dimensions and preferably delimit a volume. The rigid bodies 101, 102 may have any shape or form. For example, at least one of the rigid bodies 101, 102 may have the form of a block, shell, tray, bowl or (half-)bottle. In all Figures, the rigid body 101 is exemplarily illustrated as a shell or tray that is open on one side, respectively. The rigid bodies 101, 102 may be hollow. The rigid bodies 101, 102 may enclose a (free) space or may have a cavity that may be accessible from at least one side. Preferably, the rigid bodies 101, 102 may be suitable or configured for receiving a food product and/or serving as a receptacle for a food product. The rigid bodies 101, 102 may be symmetrical or asymmetrical. The dimensions of the rigid bodies 101, 102 may be defined by a body length, body width and body height. Preferably, the body length may be in the range of 5 cm to 50 cm. The body width may be in the range of 5 cm to 50 cm. The body height may be in the range of 5 cm to 50 cm. However, these are only examples and not to be understood as limiting. The rigid bodies 101, 102 may be made from a fibre-based material, like moulded pulp. With regards to dimensions, shape or material(s), the rigid bodies 101, 102 may be different from each other or they may be identical to each other. In FIGS. 3 and 4, the first rigid body 101 is exemplarily shown as being structurally different from the second rigid body 102. The rigid bodies 101, 102 may complement each other to the desired shape of the container 300.

Each of the rigid bodies 101, 102 is made of a rigid cellulose body 110. Examples for the rigid cellulose body 110 are provided in all Figures.

The cellulose body 110 may be made from a recyclable, biodegradable, and/or compostable material. For example, the cellulose body 110 may be made from a fibre-based material, wood pulp, sugarcane pulp, bagasse pulp, non-wood pulp, and/or cellulose based pulp in any form. It is also conceivable to provide the rigid bodies 101, 102 and/or the cellulose body 110 from paper or cardboard. The cellulose body 110 may have any shape or form. The cellulose body 110 may have a shape or form corresponding with the shape or form of the respective rigid body 101, 102. Preferably, the cellulose body 110 may form a core or frame structure of the respective rigid body 101, 102.

The cellulose body 110 is rigid. Preferably, the rigidity of the cellulose body 110 may be defined by the consistency and/or composition of its material. For example, the cellulose body 110 may be made from a material with high density and/or low gas porosity. For example, the cellulose body 110 may comprise a density in the range of 250 kg/m³ to of 1000 kg/m³. Further, the cellulose body 110 may comprise a porosity (expressed as a fraction of the volume of voids over the total volume as a percentage) between 1% and 20%. Alternatively or additionally, the cellulose body 110 may comprise an air resistance (e.g. determined by the time (seconds) it takes for 100 ml of air to pass through the material according to the Gurley method) from at least 160 Gurley seconds. Alternatively or additionally, the rigidity of the cellulose body 110 may be defined by the thickness of structures defining (contours of) the cellulose body 110. For example, the cellulose body 110 may be configured to provide sufficient axial stiffness or bending stiffness to resist typical forces (e.g. 25N) or bending moments (e.g. 1 Nm) occurring in the intended application. Preferably, the cellulose body 110 may have a material thickness B of 200 μm≤B≤1200 μm, preferably 200 μm≤B≤1000 μm. The material thickness B is exemplarily indicated in FIG. 3. Preferably, the rigidity of the cellulose body 110 may define primarily (e.g. to at least 90%/solemnly) the rigidity of the rigid bodies 11, 102.

Preferably, at least one or both of the rigid bodies 101, 102 may have a wall section 115. The wall section 115 is exemplarily illustrated in all Figures. Preferably, the wall section 115 may have the material thickness B. FIGS. 3 and 4 show this exemplarily. Preferably, the wall section 115 may extend along the entire circumference (i.e. an outside edge, perimeter) of the respective rigid body 101, 102 (in a top view). The wall section 115 may define the shape and/or contours and/or limits of the respective rigid body 101, 102. This is exemplarily indicated in all Figures.

The wall section 115 may delimit an open body volume 11. This is exemplarily illustrated in all Figures. Preferably, the wall section 115 may define the body volume 111 such that a free space inside the respective rigid body 101, 102 is formed. The free space may be accessible through an opening 140 being delimited and/or defined by the wall section 115. Preferably, the body volume 111 may be suitable as a receptacle for receiving a product, such as food products. For example, the body volume 111 may be formed as a half-shell or a bowl. Preferably, the respective rigid body 101, 102 may have an upper side comprising an access opening 140 to the body volume 111 and an opposite lower side forming a base portion 150 of the respective rigid body 101, 102. Preferably, the respective rigid body 101, 102 may be placed on a work surface with its lower side. This is exemplarily shown in FIG. 1. The base portion 150 may form a sidewall of the container 300. This is exemplarily shown in FIGS. 2 and 3. Alternatively, the base portion 150 of one of the rigid bodies 101 may form a stand-on base 151 of the container 300, while the base portion 150 of the other of the rigid bodies 102 may form a neck portion 152 or dispense opening 153 of the container 300. This is exemplarily shown in FIG. 4 showing the container 300 in the form of a stand-up bottle. The neck portion 152 can be closed as being integral with the rigid body 102 as depicted by the dotted lines in FIG. 4. The neck portion 152 may have a dispense opening 153 which can be selectively closed by an integral or separate lid. The wall section 115 may taper from the access opening 140 towards the base portion 150. This is exemplarily illustrated in FIGS. 1, 3 and 4. Preferably, the body volume 111 (and/or the free space comprised therein) may have a depth H extending between the access opening 140 of the body volume 111 and the base portion 150 of the body volume 111 opposite thereto. Preferably, the depth H may be in the range of 5 cm to 20 cm. The depth H is exemplarily illustrated in FIG. 1.

At least one of the rigid cellulose bodies 110 may comprise a see-through hole 112 penetrating the wall section 115. This is exemplarily illustrated in all Figures. It is also conceivable that at least one of the rigid cellulose body 110 may comprise more than one see-through hole 112 and thus, may comprise a plurality of see-through holes 112. This is exemplarily illustrated in FIGS. 2 to 4. The see-through holes 112 may be evenly or unevenly distributed over the rigid cellulose body 110 or preferably over at least its wall section 115. The see-through hole 112 may have any shape or form. For example, the see-through hole 112 may have a circular, oval, elliptic, rectangular, quadratic and/or curved form. However, this is not a complete enumeration and other configurations of the see-through hole(s) 112 are conceivable. For example, FIGS. 2 and 4 show the see-through hole 112 exemplarily with an elliptic shape and a circular shape. However, these are only examples. Preferably, the see-through hole(s) 112 may form a passage between the surroundings of the respective rigid body 101, 102 and the open body volume 111 delimited by the wall section 115. This is exemplarily illustrated in all Figures. Preferably, the largest extension E of the see-through hole 112 may be E≤20 mm or E≤15 mm or E≤10 mm. Alternatively or additionally, the largest extension E may be E≥1 mm or E≥2 mm. Alternatively or additionally, the largest extension E of the see-through hole 112 may be in a range of 1 mm≤E≤10 mm or 2 mm≤E≤5 mm. For example, the largest extension E may be a diameter of the see-through hole(s) 112 in case the see-through hole(s) 112 may have a circular shape. In the example illustrated in FIGS. 2 and 4, the largest extension E of the see-through hole 112 may be the largest diameter defining its elliptic shape. Generally, the size of the see-through hole(s) 112 may be dependent on the relative position of the see-through hole(s) 112 with respect to the base portion 150 and/or the access opening 140. Thereby, structural weaknesses and/or peculiarities of the respective rigid body 101, 102 can be taken into consideration. The respective rigid body 101, 102 may have the plurality of see-through holes 112 that may be all the same or that may be at least partially different to each other. Therein, the see-through holes 112 may be different in shape and/or size.

Each of the rigid bodies 101, 102 may have a circumferential flange section 131. Preferably, the flange section 131 may extend in a (single) plane 500. This is exemplarily illustrated in all Figures. In particular, FIG. 2 exemplarily shows a sectional view of the rigid body 101 with the plane 500 being the intersecting plane. Preferably, the plane 500 may be parallel to the base portion 150 of the respective rigid body 101, 102. Preferably, the flange section 131 may circumferentially surround the access opening 140 into the body volume 111, which may be delimited by the wall section 115. Moreover, the flange section 131 may extend continuously along the perimeter of the rigid body 101, 102. This is exemplarily illustrated in FIGS. 1 and 4. Preferably, the flange section 131 may be formed as a circumferentially closed portion on an external surface of the rigid body 101, 102. Alternatively or additionally, the flange section 131 may extend between two flange end sections, which may be separated from each other, such as exemplarily illustrated in FIG. 2. More preferred, the flange section 131 may extend in a step-free manner, an uninterrupted, and/or a continuous manner. Thus, the flange section 131 may be provided such that it extends without jump-discontinuities. The flange section 131 of one of the rigid bodies 101, 102 may be suitable for being connected to the flange section 131 of the respective other of the rigid bodies 102, 101 for forming a receptacle, such as the container 300. Preferably, the flange section 131 may be configured for providing a sealing area, such as required in induction sealing or ultrasonic sealing. The flange section 131 may protrude laterally away from the wall section 115. Preferably, the flange section 131 may extend towards the outside and/or the inside of the body volume 111.

Further, each of the rigid bodies 101, 102 is laminated with a laminate 120 on at least part of the rigid cellulose body 110. This is exemplarily shown in all Figures. Accordingly, the container 300 comprises at least two laminated rigid bodies 101, 102.

The laminate 120 may be made from a bio-based or petro-based material. For example, the material of the laminate 120 may be a polymer. Preferably, the laminate 120 may be biodegradable or recyclable. For example, the laminate 120 may be any combination of one or more of the group of PLA, PBAT, TPS, PHA, PP, PE, PET, PGA and/or PBS. Alternatively or additionally, the laminate 120 may comprise an electrically conducting material. For example, the laminate 120 may comprise Aluminium. Preferably, the laminate 120 may comprise a layered structure, such as a multi-ply structure. The layered structure may comprise any combination of the aforementioned group of materials. Preferably, the laminate 120 may comprise a layer of electrically conducting material that is sandwiched between two polymer layers. The laminate 120 may comprise electrically conducting wires or strands that are embedded in polymer, wax and/or cellulose (based) layer and/or that are sandwiched between polymer, wax and/or cellulose (based) layers. Preferably, the laminate 120 may be a metallized paper, metallized film and/or a metallized polymer. It is also conceivable that the laminate 120 may be a blend of an electrically conducting material and a non-conducting material. The laminate 120 may be stretchable, translucent and/or transparent. Alternatively or additionally, the laminate 120 may be water resistant and/or fat resistant. The laminate 120 may be from (or comprise) a food safe material. Preferably, the laminate 120 may be suitable for providing an oxygen and/or UV radiation barrier. Alternatively or additionally, the laminate 120 may be (or comprise) a sealant, for example, to be used in (heat) sealing applications. The laminate 120 may be (provided as) a film or a foil. The laminate 120 may have a material thickness T of 25 μm≤T≤150 μm, preferably 60 μm≤T≤100 μm. In case of a multi-ply structure, for example, the material thickness T may be the total thickness. FIG. 1 shows this exemplarily. Preferably, the laminate 120 may be configured to be of a material and/or thickness T that is suitable for being melted in ultrasonic and/or induction sealing. For example, it is also conceivable that the laminate 120 may be provided with a layer of electrically conducting material only on sections or in areas of the laminate 120, where (later) the two rigid bodies 101, 102 are to be joined.

The laminate 120 may be adhered to the respective cellulose body 110 in a vacuum lamination process. Therein, a vacuum may be applied at least via the see-through hole 112 so that it is laminated onto the respective cellulose body 110 at least at the wall section 115 to cover the see-through hole 112. Due to the application of vacuum, it may be possible to attach the laminate 120 firmly to the cellulose body 110, preferably in a manner that the laminate 120 adheres to the cellulose body 110 like a skin. Preferably, the laminate 120 may be joined with the cellulose body 110 by forming an adhesive bond.

Alternatively or additionally, for example, one or more sealant layers may be used to connect (adhere) an electrically conducting material, such as a metallized paper or metallized polymer or metallized film, (directly and/or as a first layer) to the respective cellulose body 110. The sealant used for this purpose may be a sealant typically used in heat sealing applications, for example.

The laminated rigid bodies 101, 102 may have a structure, for example, that may be arranged in layers, plies, slats, tiers or as strata. Therein, preferably the laminate 120 may form one of the layers, plies, slats, tiers or strata. For example, another layer of the laminated rigid bodies 101, 102 may be formed by an electrically conducting coating applied (locally) to at least a portion of (at least one of) the respective cellulose body 110. The laminate 120 may be provided (laminated) at any part of the cellulose body 110. Preferably, the laminate 120 may be provided at the wall section 115. This is exemplarily illustrated in all Figures. Preferably, at least the see-through hole(s) 112 (and surrounding portions of the wall section 115) may be covered by the laminate 120. The laminate 120 may cover the inside of the respective rigid body 101, 102 and/or external surfaces of the respective rigid body 101, 102. For example, in FIGS. 1 to 4, the laminate 120 is exemplarily illustrated as only covering the inside surfaces of the rigid bodies 101, 102. However, it is also conceivable that the laminate 120 may cover at least partial external surfaces of the rigid bodies 101, 102 (and/or cellulose body 110). The flange section 131 may be covered by the laminate 120. This is exemplarily illustrated in FIGS. 1 and 4. However, it is also conceivable that the flange section 131 may be free from the laminate 120. This is exemplarily shown in FIG. 2 and indicated by a broken line in FIG. 1.

The rigid bodies 101, 102 are joined by ultrasonic welding and/or induction sealing.

For example, by completing ultrasonic welding and/or induction sealing, the laminate 120 laminated on the rigid bodies 101, 102 may be melted locally at the sealing location, e.g. due to absorption of vibrational energy, and thereby bind together. However, it is also conceivable that—in case the rigid bodies 101, 102 are joined by ultrasonic welding and without melting the laminate 120—the vibrational energy may cause lignin contained inside the cellulose bodies 110 to enter the sealing area between the two rigid bodies 101, 102 so that a structural bond can be formed therebetween. Accordingly, the rigid bodies 101, 102 may be joined with a structural bond being characterised by a defined tensile seal strength. The seal strength may be tested in accordance with industrial norms, such as ASTM F88/F88M-15. For example, to determine a seal's tensile strength, a sample with a defined seal width measured across the seal, i.e. orthogonal to its circumferential extension, may be pulled apart at a defined rate (e.g. 100 mm/min) while measuring the force resistance during the seal separation. Preferably, the tensile seal strength of the joined rigid bodies 101, 102 may be at least 100N with a minimum seal width of 2 mm.

The rigid bodies 101, 102 are joined by ultrasonic welding and/or induction sealing at interface sections 130 of the rigid bodies 101, 102. This is exemplarily illustrated in FIGS. 3 and 4 through sealing 330 being formed between the interface sections 130. The interface sections 130 are also exemplarily shown in FIGS. 1 and 2. Preferably, the connection between the two rigid bodies 101, 102 along the interface section(s) 130 may be a hermetic, preferably liquid tight and/or gas tight seal. The interface sections 130 may define an area to be sealed (a sealing area) in the ultrasonic welding process.

Each of the rigid bodies 101, 102 may comprise one or more of the interface sections 130. Preferably, the interface section(s) 130 may be formed by a surface or portion of the rigid bodies 101, 102 on a side facing away from the body volume 111. The interface section(s) 130 may protrude outwards with respect to the body volume 111. The interface section(s) 130 may extend within a single plane, preferably the plane 500. Preferably, the interface section(s) 130 may extend along the (entire) circumference (i.e. an external edge, perimeter) of the respective rigid body 101, 102. The interface section(s) 130 may be formed by (a portion of) the cellulose body 110. For joining the rigid bodies 101, 102, the interface sections 130 may be arrangeable such that they preferably at least partially overlap with each other when the rigid bodies 101, 102 are adjoined. For example, the interface sections 130 may be formed by the flange sections 131. This is exemplarily illustrated in all Figures. At least some or all of the interface sections 130 may be laminated with the laminate 120 so that preferably the laminate 120 allows for joining the rigid bodies 101, 102. Alternatively or additionally, at least some or all of the interface sections 130 may be at least partially covered (or coated) by an electrically conducting material and may be subsequently laminated with the laminate 120. However, it is also conceivable that an additional sealant may be used during the ultrasonic welding and/or induction sealing process. For example, at least some or all of the interface sections 130 may be at least partially covered (or coated) by an electrically conducting layer and the additional sealant is added thereon (on top). Preferably, the additional sealant may be a material of the materials described above for the laminate 120 or at least a material with the characteristics described above for the laminate 120. For example, the additional sealant may be a polymer, such as PE (e.g. low-density PE), or another heat seal layer. Therein, it is also conceivable, for example, to use one or more sealant layers to connect (adhere) the electrically conducting layer, such as a metallized paper or metallized polymer or metallized film, (directly and/or as a first layer) to the respective interface section 130.

Generally, it is possible to achieve good results on the sealing quality with and without the addition of the additional sealant(s) for ultrasonic welding and/or for induction sealing of the rigid bodies 101, 102. Good results were observed, for example, for the cellulose body 110 (having the material thickness T in the range of 30 μm≤T≤100 μm) being laminated with a laminate material comprising at least PLA and PBAT, wherein preferably the (total) material thickness B of the laminate 120 may be around 50 μm to 200 μm, 50 μm to 100 μm, 100 μm to 150 μm, or 150 μm to 200 μm (with the laminate 120 being preferably provided as a film). Alternatively or additionally, the laminate 120 may be a material comprising PLA, PBAT and TPS. Therein, preferably, the laminate 120 may comprise a layer of PBAT with a film thickness of around 100 μm. Alternatively or additionally, the laminate 120 may be a material comprising PA, PBAT and the additional sealant (preferably having a sealant film thickness of 20 μm to 70 μm, more preferred 50 μm) may be added for the ultrasonic welding and/or the induction sealing. However, these are only examples and numerous other configurations exist that can lead to high-quality sealing.

The rigid bodies 101, 102 are joined such that the rigid bodies 101, 102 together enclose an inner volume 311 of the container 300. The inner volume 311 is at least partially delimited by the laminate 120. This is exemplarily shown in FIGS. 3 and 4.

The inner volume 311 may form a receptacle or cavity of the container 300. The inner volume 311 may comprise the open body volume 111. In FIGS. 3 and 4, for example, the inner volume 311 is illustrated as comprising the open body volume 111 of the first rigid body 101 and of the second rigid body 102. Preferably, the inner volume 311 may have a volume between 200 ml and 10l. The inner volume 311 may be surrounded at least partially by the wall sections 115 of the respective rigid bodies 101, 102. The laminate 120 may form a mantle surface inside the container 300 or a mantle surface of an inner surface of the container 300. Preferably, the laminate 120 may (fully) cover the cellulose body 110 on surfaces thereof delimiting the inner volume 311. Preferably, the inner volume 311 may have the dispense opening 153, e.g. at the base portion 150 of one of the rigid bodies 102 (in FIG. 4 the upper rigid body 102) and/or on a side of the container 300 intersecting with the plane 500. Preferably, the plane 500 may be a symmetry plane of the container 300 and/or of the inner volume 311.

The inner volume 311 may be at least partially filled with a food product, preferably a liquid, viscous, pasty, powdery, crumbly, or pourable food product. For example, the food product may be drinking water or a milk shake. Preferably, the laminate 120 may provide a (food safe) liquid barrier of the container 300.

A further aspect of the invention relates to a method of making a container, such as the above-described container 300.

In the method, at least two of the above-described rigid bodies 101, 102 are provided. Therein, each of the rigid bodies 101, 102 is made of a rigid cellulose body 110 and a laminate 120 that is laminated on at least part of the rigid cellulose body 110.

The rigid bodies 101, 102 may be supplied and placed inside a work area. Preferably, the work area may comprise an ultrasonic welding system and/or an induction sealing system (not illustrated). Typically, for ultrasonic welding, the workpieces are sandwiched between a sealing anvil and a sonotrode, which both may be components of the ultrasonic welding system. The ultrasonic welding system may further comprise an electronic ultrasonic generator for generating a high-power electric signal that is transmitted to the sonotrode for converting the high-power electric signal into a mechanical high frequency vibration as well as a mechanical press to join the two workpieces under pressure. Preferably, at least one of the two rigid bodies 101, 102 may be placed on the sealing anvil and more preferred may be secured thereon. For induction sealing, the workpieces may be placed adjacent to at least one electromagnet. Alternatively or additionally, the workpieces may be placed between two electromagnets. Preferably, the workpieces and the electromagnet(s) may be arranged with respect to each other such a magnetic field generated by the electromagnet(s) can penetrate the sealing location, preferably the interface sections 130.

The method further comprises the step of adjoining the rigid bodies 101, 102 at their respective interface sections 130 so that they together enclose the inner volume 311, which is at least partially delimited by the laminate 120.

For example, the rigid bodies 101, 102 may be arranged such that they are aligned with each other, preferably in at least two directions. The rigid bodies 101, 102 may abut onto each other via their respective interface sections 130. Preferably, the rigid bodies 101, 102 may be arranged such that the plane 500 of each of the rigid bodies 101, 102 (in which the respective interface sections 130 extend) overlaps and/or is aligned. The interface sections 130 may be preferably arranged such that they at least partially overlap with each other when the rigid bodies 101, 102 are adjoined. As mentioned above, the interface sections 130 of each rigid body 101, 102 may be both laminated with the laminate 120 so that preferably the laminate 120 of each rigid body 101, 102 allows for joining the rigid bodies 101, 102. However, it is also conceivable to join the rigid bodies 101, 102 without the laminate 120, for example with none or only one of the rigid bodies 101, 102 at least partially comprising the laminate 120 on the interface section 130. Also, it is conceivable that only one of the rigid bodies 101, 102 may comprise an electrically conducting material suitable for induction sealing. Alternatively or additionally, the additional sealant may be added instead of the laminate 120 or in addition to the laminate 120 being provided on one or each of the rigid bodies 101, 102. However, this is not a complete enumeration and other examples are conceivable.

The rigid bodies 101, 102 are joined by ultrasonic welding and/or by induction sealing of the interface sections 130 to form the container 300.

The step of ultrasonic welding and/or induction sealing may be carried out on the inside and/or the outside of the container 300. It is also conceivable that ultrasonic welding may be carried out as well as (and at the same time as) induction sealing. Naturally, also only one or the other of ultrasonic welding and induction sealing may be carried out in the joining process.

Preferably, for ultrasonic welding, the sonotrode may be guided to come into contact with the rigid bodies 101, 102 at the interface section(s) 130 of at least one of the rigid bodies 101, 102. The step of ultrasonic welding may be carried out with a frequency in a range of 15 kHz to 30 kHz, preferably at 20 kHz.

In comparison, for induction sealing, the electromagnet may not come into contact with anyone of the rigid bodies 101, 102. Thereby, for example, contamination of a product inside one of the rigid bodies 101, 102 can be avoided. The step of induction sealing may be carried out with a power level in a range of 0.5 kW to 6.0 kW, more preferred 3.0 kW to 4.0 kW. Alternatively or additionally, in the step of induction sealing, the magnetic field may vary with a frequency in a range of 5 kHz to 100 kHz, preferably at 50 kHz.

Preferably, the step of joining may last in a range from 0.01 seconds to 1 seconds, preferably in a range from 0.1 seconds to 0.2 seconds. Thereby, for example, it can be avoided that the sealing between the two rigid bodies 101, 102 is insufficient by either forming too little or too much binding material between the respective structures.

For ultrasonic welding, the two rigid bodies 101, 102 may be sandwiched between the sonotrode and the sealing anvil under pressure. For this, for example, the step of ultrasonic welding may be carried out while pressure is applied by the sonotrode and/or the sealing anvil to the interface sections 130 (on preferably opposite sides thereof). Alternatively or additionally, the electromagnet may be used to pressurize the two rigid bodies 101, 102 for the sealing step. Therein, a counterpart (such as a structure with a sharp edge) may be provided for acting against the pressure applied by the electromagnet. Preferably, the sealing pressure may be in the range of 5 bar to 30 bar. The pressure may have a direction that is parallel to the normal of the plane 500.

The step of ultrasonic welding and/or induction sealing may be carried out by repeatedly moving the sonotrode and/or electromagnet(s) along the circumference (perimeter) of the rigid bodies 101, 102. Preferably, the sonotrode or the electromagnet may have a jaw surface with a surface area of 50 mm×10 mm. More preferred, the jaw surface of the sonotrode may have a surface contour or surface features, such as ribs or a grid.

Preferably, the container 300 (or its inner volume 311) may be filled with a food product after completing the step of ultrasonic welding and/or induction sealing. The method may be completed manually or fully automated, for example with a vertical or horizontal form fill seal machine.

The invention is not limited by the embodiments as described hereinabove, as long as being covered by the appended claims. All the features of the embodiments described hereinabove can be combined in any possible way and can be provided interchangeably.

1. A method of making a container, comprising:
providing at least two laminated rigid bodies, each made of a rigid cellulose body and a laminate that is laminated on at least part of the rigid cellulose body,
adjoining the rigid bodies at interface sections thereof so that they together enclose an inner volume, which is at least partially delimited by the laminate, and
joining the rigid bodies by ultrasonic welding and/or induction sealing of the interface sections to form the container.

2. The method according to claim 1, wherein at least one or both of the rigid bodies have a three-dimensional form preferably having a wall section delimiting an open body volume, wherein the inner volume.

3. The method according to claim 1, wherein the rigid bodies each have a circumferential flange section forming the interface sections.

4. The method according to claim 1, wherein the interface sections are each laminated with the laminate so that the laminate allows for joining the rigid bodies.

5. The method according to claim 1, wherein the step of ultrasonic welding is carried out with a frequency in a range of 15 kHz to 30 kHz.

6. The method according to claim 1, wherein at least one of the rigid cellulose bodies comprises a see-through hole that is covered by the laminate, wherein the see-through hole.

7. The method according to claim 1, wherein a food product is provided in the inner volume before or after joining the rigid bodies.

8. A container comprising at least two laminated rigid bodies each made of a rigid cellulose body and a laminate laminated on at least part of the rigid cellulose body, wherein the rigid bodies are joined at interface sections thereof so that the rigid bodies together enclose an inner volume of the container that is at least partially delimited by the laminate.

9. The container according to claim 8, wherein at least one or both of the rigid bodies have a three-dimensional form and preferably a wall section delimiting an open body volume.

10. The container according to claim 8, wherein the interface sections are circumferential flanges.

11. The container according to claim 8, wherein at least one of the rigid cellulose bodies comprises a see-through hole that is covered by the laminate.

12. The container according to claim 11, wherein the largest extension E of the see-through hole is E≤20 mm.

13. The container according to claim 8, wherein the rigid cellulose body has a material thickness B of 200 μm≤B≤1200 μm.

14. The container according to claim 8, wherein the laminate of each rigid body has a material thickness T of 25 μm≤T≤150 μm.

15. The container according to claim 8, wherein the inner volume is at least partially filled with a food product.
